(19) United States
(12) Patent Application Publication
(10) Pub. No.: US 2017/0100993 A1
(43) Pub. Date: Apr. 13, 2017

(54) PHOTOCHROMIC WINDSHIELD

(71) Applicant: Dewayne Leroy Casey, Baltimore, MD (US)

(72) Inventor: Dewayne Leroy Casey, Baltimore, MD (US)

(21) Appl. No.: 15/291,620

(22) Filed: Oct. 12, 2016

Related U.S. Application Data
(60) Provisional application No. 62/240,142, filed on Oct. 12, 2015.

(51) Int. Cl. B60J 3/04; G02B 5/23

(52) U.S. Cl. CPC B60J 3/04; G02B 5/23

(57) ABSTRACT

An automobile including a photochromic windshield is provided. The automobile includes a frame and at least one drive motor supported by the frame. A plurality of wheels supports the frame and is driven by the at least one drive motor. A windshield is secured to the frame. The windshield includes a transparent material and a photochromic substance.

### CROSS-REFERENCE TO RELATED APPLICATION

This application claims the benefit of priority of U.S. provisional application No. 62/240,142, filed Oct. 12, 2015, the contents of which are herein incorporated by reference.

### BACKGROUND OF THE INVENTION

The present invention relates to automobile windows and, more particularly, to a photochromic windshield.

The windshield of an automobile is the front window. Modern windshields are generally made of laminated safety glass, a type of treated glass, which consists of two (typically) curved sheets of glass with a plastic layer laminated between them for safety, and are bonded into the window frame. Currently, motor vehicles windows do not protect passengers and/or items from becoming overheated and potentially expiring unnecessarily. The intense direct sunlight exposure and the UV-rays increases the temperature drastically within all vehicles.

As can be seen, there is a need for protective windows and windshield for vehicles.

### SUMMARY OF THE INVENTION

In one aspect of the present invention, an automobile comprises: a frame; at least one drive motor supported by the frame; a plurality of wheels supporting the frame, wherein at least one of the plurality of wheels is driven by the at least one drive motor; and a windshield secured to the frame and comprising a transparent material and a photochromic substance.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention illustrating a tinted windshield;

FIG. 2 is a perspective view of an embodiment of the present invention illustrating a tinted windshield;

FIG. 3 is a perspective view of an embodiment of the present invention illustrating a tinted windshield;

FIG. 4 is a perspective view of an embodiment of the present invention illustrating a tinted windshield; and

FIG. 5 is a perspective view of an embodiment of the present invention illustrating a tinted windshield.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an automatic tinting shield glass. The present invention prevents the interior of the vehicle from overheating. The present invention may include an automatic tint up to about a 30% hue during sunny weather, greatly reducing harmful ultra violet (UV) rays. With the protection of present invention on an exemplary vehicle, harmful UV-rays are blocked and deflected away. Thus, the present invention allows the vehicle to remain significantly cooler during exposure to direct sunlight.

The present invention may include a windshield or any window of vehicle. Sunlight activated tinting solution, partition or material (photochromic substance) is embedded within the windshield. The photochromic substance may be coated and/or blended within the windshield during production so as the two components are able to become one unit in uniform.

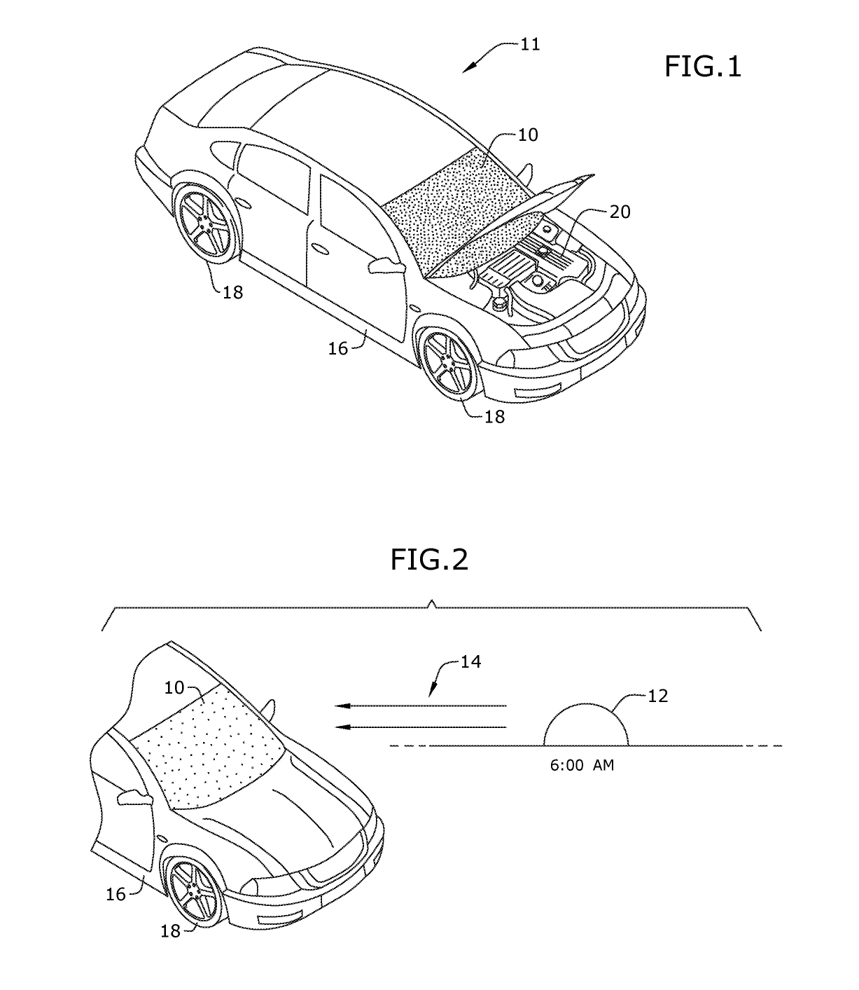

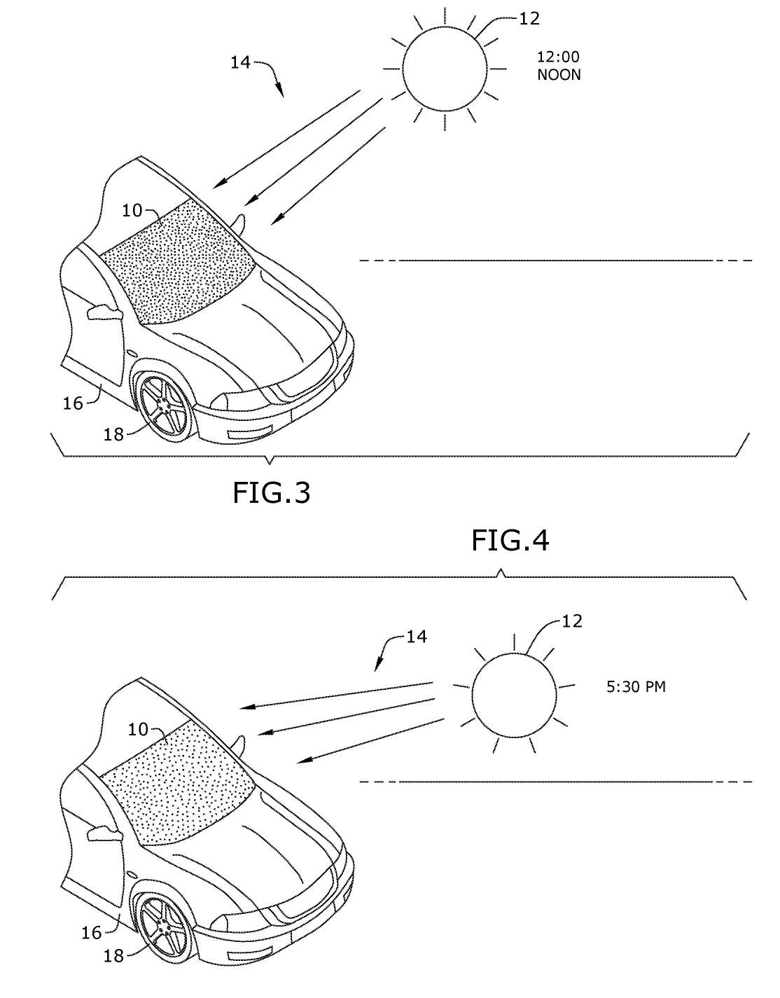

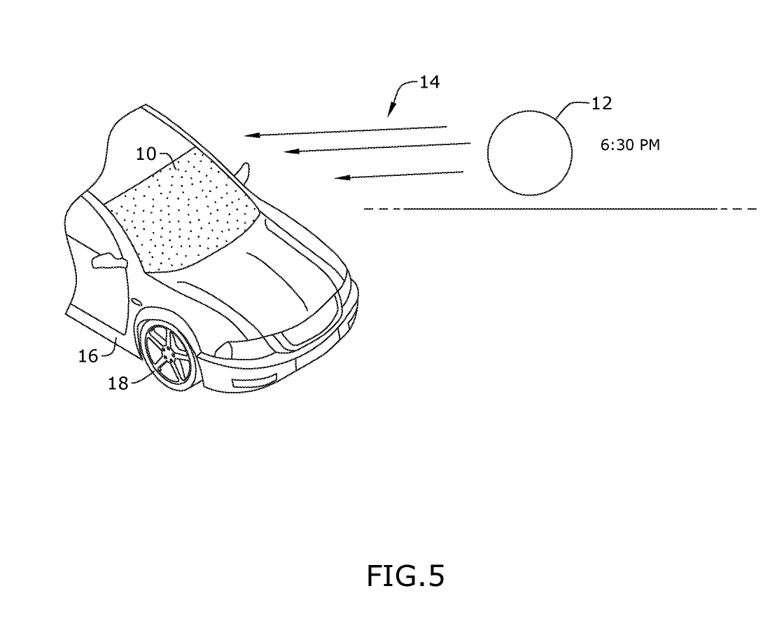

Referring to FIGS. 1 through 5, the present invention includes an automobile 11. The automobile 11 includes a frame 16 and at least one drive motor 20 supported by the frame 16. A plurality of wheels 18 supports the frame 16 and is driven by the at least one drive motor 20. A windshield 10 is secured to the frame 16. The windshield 10 includes a transparent material and a photochromic substance.

As mentioned above, the windshield 10 includes a transparent material with a photochromic substance, forming a photochromic windshield 10. The photochromic windshield 10 darkens on exposure to types of light of sufficient intensity, most commonly ultraviolet (UV) rays 14 from the sun 12. In the absence of activating light, the photochromic windshield 10 returns to a clear state.

The photochromic windshield 10 may be made of glass, polycarbonate, another plastic or a combination thereof. The photochromic windshield 10 is dark in bright sunlight, but clear in low ambient light conditions. The photochromic windshield 10 may darken significantly within about a minute of exposure to bright UV rays 14.

In certain embodiments, the photochromic substance includes molecules of silver chloride or another silver halide embedded in the windshield 10. They are transparent to visible light without a significant ultraviolet component, which is normal for artificial lighting. In certain embodiments, the photochromic substance is organic photochromic molecules that when exposed too ultraviolet (UV) rays 14, as in direct sunlight, undergo a chemical process that causes them to change shape and absorb a significant percentage of the visible light, i.e., they darken. The process is reversible. Once the windshield 10 is removed from strong sources of UV rays 14, the photochromic compounds return to their transparent state.

In certain embodiments, the transparent material may be made of glass. In such embodiments, the photochromic substance includes microcrystalline silver halides, such as silver chloride, which is embedded in the glass substrate.

In certain embodiments, the transparent material may be made of plastic. In such embodiments, the photochromic substance may include organic photochromic molecules, such as oxazines and naphthopyrans to achieve the reversible darkening effect.

The transparent material of the present invention may include glass layers and plastic layers. In such embodiments, the photochromic substance within the glass layers may include a microcrystalline silver halide and the photochromic substance within the plastic layer may include the organic photochromic molecules, such as oxazines and napthopyrans.

It should be understood, of course, that the foregoing relates to exemplary embodiments of the invention and that modifications may be made without departing from the spirit and scope of the invention as set forth in the following claims.

What is claimed is:

1. An automobile comprising:
a frame;
at least one drive motor supported by the frame;
a plurality of wheels supporting the frame, wherein at least one of the plurality of wheels is driven by the at least one drive motor; and
a windshield secured to the frame and comprising a transparent material and a photochromic substance.

2. The automobile of claim 1, wherein the transparent material is glass.

3. The automobile of claim 2, wherein the photochromic substance comprises a microcrystalline silver halide.

4. The automobile of claim 1, wherein the transparent material is plastic.

5. The automobile of claim 4, wherein the photochromic substance comprises organic photochromic molecules.

6. The automobile of claim 5, wherein the organic photochromic molecules comprises at least one of oxazines and napthopyrans.

7. The automobile of claim 1, wherein the transparent material comprises at least one layer of glass and a layer of plastic.

8. The automobile of claim 1, wherein the photochromic substance is embedded within at least one of the layer of glass and the layer of plastic.

9. The automobile of claim 8, wherein the photochromic substance is embedded within the layer glass and the layer of plastic.

10. The automobile of claim 9, wherein the photochromic substance within the at least one layer of glass comprises a microcrystalline silver halide and the photochromic substance within the layer of plastic comprises at least one of oxazines and napthopyrans.
